(19) United States
(12) Patent Application Publication
(10) Pub. No.: US 2026/0239241 A1
(43) Pub. Date: Aug. 13, 2026

(54) SYSTEMS AND METHODS FOR ENHANCED INTER-FREQUENCY AND INTRA-FREQUENCY MEASUREMENT WITHOUT MEASUREMENT GAP

(71) Applicant: APPLE INC., Cupertino, CA (US)

(72) Inventors: Qiming Li, Beijing (CN); Yang Tang, San Jose, CA (US); Jie Cui, San Jose, CA (US); Xiang Chen, Campbell, CA (US); Manasa Raghavan, Sunnyvale, CA (US); Yuexia Song, Beijing (CN); Dawei Zhang, Saratoga, CA (US)

(21) Appl. No.: 19/151,859

(22) PCT Filed: Mar. 9, 2023
(86) PCT No.: PCT/CN2023/080482

§ 371 Date: Jul. 29, 2025

(51) Int. Cl. H04W 56/00; H04W 72/0457; H04W 72/51; H04W 74/0816

(52) U.S. Cl. CPC H04W 56/0015; H04W 72/0457; H04W 72/51; H04W 74/0816

(57) ABSTRACT

Systems and methods for performing inter-frequency and intra-frequency measurements without measurement gap use are discussed herein. A UE receives, from a network, configuration information for performing an inter-frequency or intra-frequency synchronization signal block (SSB) measurement outside of an active bandwidth part (BWP) without a measurement gap, and, in response, performs, without using the measurement gap, the inter-frequency/intra-frequency SSB measurement on an inter-frequency/intra-frequency SSB that is located outside of the active BWP and within a UE channel bandwidth (CBW) corresponding to the active BWP. Capability information detailing whether the UE supports this behavior may be provided from the UE to the network. The network may provide a threshold for a measurement object (MO) that is used by the UE to determine whether to perform such SSB measurements without a measurement gap. The UE may provide the network with assistance information indicating a UE intent or preference for such SSB measurements.

### TECHNICAL FIELD

This application relates generally to wireless communication systems, including wireless communications systems capable of performing inter-frequency and/or intra-frequency measurements.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table providing details of a parameter used by a UE to indicate its support of performing/capability to perform inter-frequency L3 measurements without the use of a measurement gap under certain conditions, according to some embodiments.

FIG. 2 illustrates a diagram of a first neighbor SSB and a second neighbor SSB with respect to a serving SSB that is within a UE's active BWP, according to embodiments herein.

FIG. 3 illustrates a diagram of a first neighbor SSB and a second neighbor SSB with respect to a serving SSB that is within a UE's active BWP, according to embodiments herein.

FIG. 4 illustrates a diagram of a first neighbor SSB and a second neighbor SSB with respect to a serving SSB that is within a UE's active BWP, according to embodiments herein.

FIG. 5 illustrates a diagram of a neighbor SSB with respect to a serving SSB that is within a UE's active BWP, according to embodiments herein.

FIG. 6 illustrates a method of a UE, according to embodiments herein.

FIG. 7 illustrates a method of a RAN, according to embodiments herein.

FIG. 8 illustrates a method of a UE, according to embodiments herein.

FIG. 9 illustrates a method of a RAN, according to embodiments herein.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication networks, a UE is not configured to perform inter-frequency L3 measurement (e.g., an L3 measurement on a different carrier from a current carrier of the UE) at the same time as it performs data receive (Rx) and/or transmit (Tx) operations of its current serving cell. Instead, it may be that the network provides the UE with a measurement gap during which data Rx and/or Tx operations on the serving cell are paused. The UE then performs the inter-frequency measurement during the measurement gap.

Some wireless communications networks enhance this behavior. For example, it may be that in such enhanced networks, the UE can (optionally) indicate its support for performing/capability to perform inter-frequency L3 measurements without the use of a measurement gap under certain conditions.

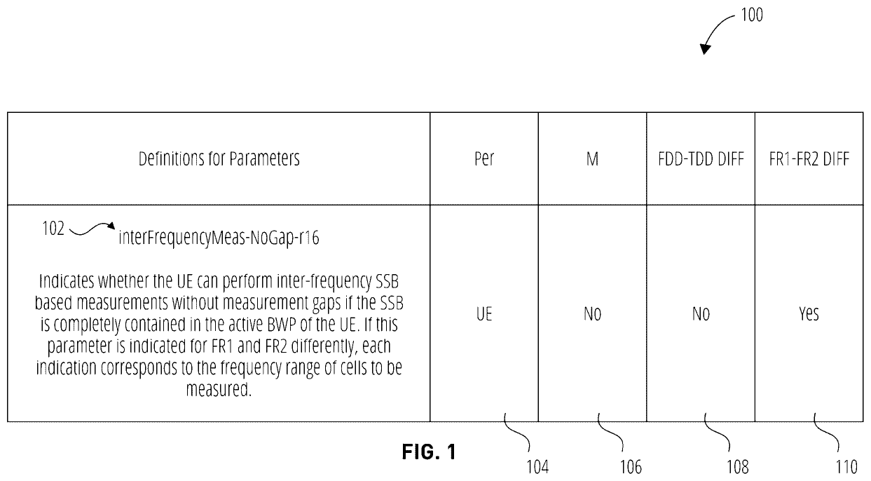

FIG. 1 illustrates a table 100 providing details of a parameter 102 used by a UE to indicate its support of performing/capability to perform inter-frequency L3 measurements without the use of a measurement gap under certain conditions, according to some embodiments.

As illustrated, the parameter 102 may be an interFrequencyMeas-NoGap-r16 parameter of an NR system (e.g., as is defined in 3GPP Technical Specification (TS) 38.306, version 17.3.0 (December 2022), Section 4.2.9). The parameter 102 may indicate whether the UE can perform inter-frequency synchronization signal block (SSB) based measurements without measurement gaps if the SSB is completely contained in an active BWP of the UE. In some cases, this parameter may be indicated differently/independently for applicability in a corresponding frequency range (e.g., may be indicated differently/independently for each of FR1 and/or FR2).

The table 100 further illustrates that the parameter 102 may be configured on a per-UE basis 104, that the parameter 102 is non-mandatory 106, that the parameter 102 may be specified independently/differently according to per-frequency division duplex (FDD) or time division duplex (TDD) functionalities 108, and that the parameter 102 may be specified independently/differently according to differing per-frequency range functionalities 110.

In some cases, there may be corresponding requirements for the parameter 102. For example, in an NR system, if the UE supports interFrequencyMeas-NoGap-r16 and a flag interFrequencyConfig-NoGap-r16 is configured by the network, the UE may need to be able to identify a new detectable inter-frequency cell within T_{identify_inter_without_index} if the UE is not indicated to report an SSB based radio resource management (RRM) measurement result with the associated SSB index (e.g., a reportQuantityRsIndexes parameter or maxNrofRSIndexesToReport parameter is not configured). Otherwise, the UE may need to be able to identify a new detectable inter-frequency cell within T_{identify_inter_with_index}. Further, the UE may need to be able to identify a new detectable inter frequency SSB of an already detected cell within T_{identify inter without index}. See 3GPP TS 38.133, version 17.8.0 (December 2022), Section 9.3.9.1.

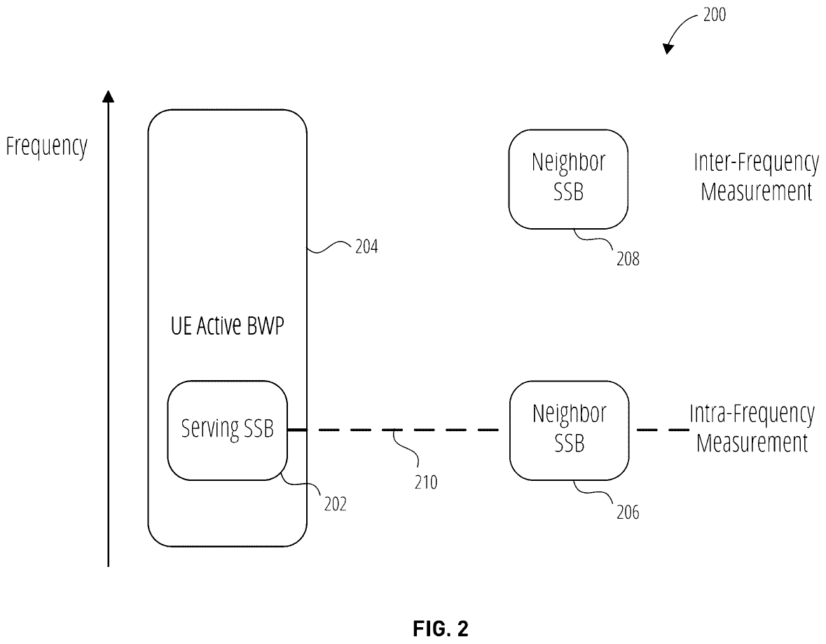

FIG. 2 illustrates a diagram 200 of a first neighbor SSB 206 and a second neighbor SSB 208 with respect to a serving SSB 202 that is within a UE's active BWP 204, according to embodiments herein.

In some wireless communications systems, the nature of an inter-frequency measurement without the use of a measurement gap may be defined. For example, in some NR wireless communications systems, an inter-frequency SSB based measurement without a measurement gap (e.g., without either of a full measurement gap or a network controlled small gap (NCSG)) may be performed at a UE that is capable of interFrequencyMeas-NoGap, provided that the UE supports the use of the interFrequencyMeas-Nogap-r16 parameter and that the SSB is completely contained in the active BWP of the UE.

The diagram 200 illustrates a carrier 210 corresponding to the active serving cell of the UE. As may be seen, the serving SSB 202 serves as a measurement object (MO) corresponding to that carrier 210 with respect to the serving cell and is within the active BWP 204 of the UE. Further, a measurement of the first neighbor SSB 206 would be considered an intra-frequency measurement because, similarly to the serving SSB 202, it arrives on the carrier 210.

A measurement of the second neighbor SSB 208 would instead be considered an inter-frequency measurement because it does not arrive on the carrier 210. It is further noted that because, inter alia, the second neighbor SSB 208 arrives within the active BWP 204, it may be measured by the UE without the use of a measurement gap.

In some wireless communications systems, similarly to the case of L3 inter-frequency measurement discussed in relation to FIG. 2, it may be that various RRM measurements (e.g., L1 measurement for radio link management (RLM), beam management (BM), and/or beam failure detection (BFD) can only be performed based on a reference signal that is located within an active BWP.

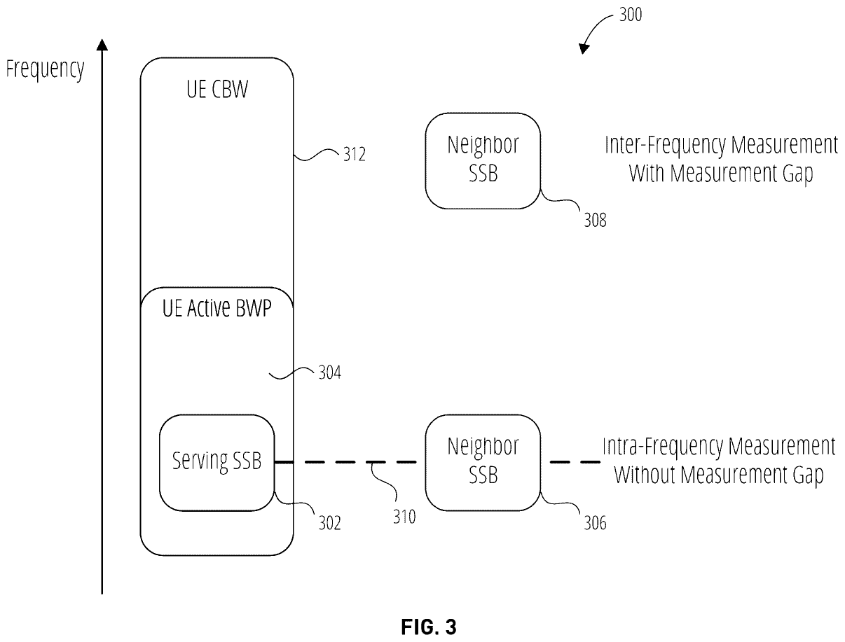

FIG. 3 illustrates a diagram 300 of a first neighbor SSB 306 and a second neighbor SSB 308 with respect to a serving SSB 302 that is within a UE's active BWP 304, according to embodiments herein. The diagram 300 illustrates a carrier 310 corresponding to the active serving cell of the UE. As may be seen, the serving SSB 302 serves as an MO corresponding to that carrier 310 with respect to the serving cell and is located within the active BWP 304 of the UE.

An intra-frequency measurement of the first neighbor SSB 306 (which also corresponds to the carrier 310) is performable by the UE without the use of a measurement gap because the first neighbor SSB 306 falls within the active BWP 304.

However, in some wireless communication systems, an inter-frequency measurement of the second neighbor SSB 308 can only be performed by the UE during/with the use of a measurement gap. As illustrated, the second neighbor SSB 308 is located within the UE channel bandwidth (CBW) 312 (the overall bandwidth of the channel corresponding to the carrier 310 as understood by the UE) but is outside of the active BWP 304. Accordingly, in various wireless communication systems, as illustrated in FIG. 3, the UE is configured to use a measurement gap to perform the measurement of the second neighbor SSB 308 because the second neighbor SSB 308 is outside of the active BWP 304.

It has been recognized that it may be beneficial to provide a mechanism through which a UE may perform RRM measurements (e.g., for one or more of RLM, BM, and/or BFD) on an SSB that is located outside an active BWP without the use of measurement gaps. For example, performing RRM measurements without using measurement gaps may increase UE data throughput in various circumstances as compared to cases where a measurement gap is used.

It has also been recognized that UEs with relatively advanced radio frequency (RF) capabilities may be equipped with hardware that can support RRM measurements on SSBs located outside an active BWP without the use of a measurement gap. For example, a UE may include hardware that is capable of using an actual BWP that is wider than the active BWP in order to receive an SSB that is near to but outside the active BWP. Additionally or alternatively, the UE may include multiple RF chains and may correspondingly be capable of using a first RF chain to perform Rx and/or Tx operations on the active BWP while simultaneously using a second RF chain to receive an SSB that is located outside the active BWP.

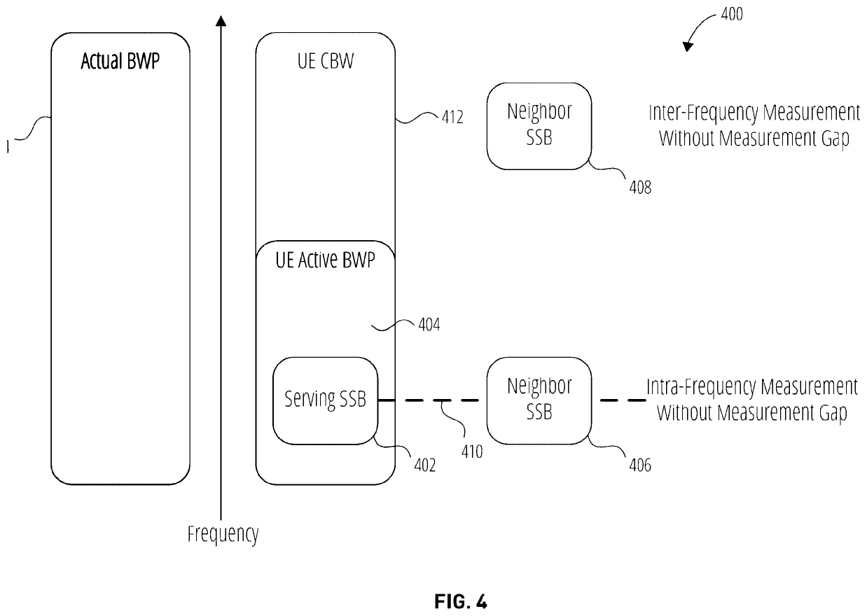

FIG. 4 illustrates a diagram 400 of a first neighbor SSB 406 and a second neighbor SSB 408 with respect to a serving SSB 402 that is within a UE's active BWP 404, according to embodiments herein. The diagram 400 illustrates a carrier 410 corresponding to the active serving cell of the UE. As may be seen, the serving SSB 402 serves as an MO corresponding to that carrier 410 with respect to the serving cell and is within the active BWP 404 of the UE.

An intra-frequency measurement of the first neighbor SSB 406 (which also corresponds to the carrier 410) is performable by the UE without the use of a measurement gap because the first neighbor SSB 406 falls within the active BWP 404.

As illustrated, the second neighbor SSB 408 is located within the UE CBW 412 but outside of the active BWP 404. In some cases, an inter-frequency measurement of the second neighbor SSB 408 may be performed by the UE without the use of a measurement gap. For example, it may be that the UE is capable of using an actual BWP 414 that is larger than the active BWP 404 and that the second neighbor SSB 408 is located within this actual BWP 414. Under such circumstances, the UE may receive and perform measurement on the second neighbor SSB 408 while simultaneously performing Rx/Tx functions corresponding to the defined active BWP 404 by functionally applying the actual BWP 414.

In some embodiments, a UE may send capability information to the network that indicates whether the UE is capable of performing inter-frequency measurements without using a measurement gap. For example, such capability information may be provided in an interFrequencyMeasOutsideBWP-NoGap information element that is transmitted to the network by the UE. Capability information may indicate, for example, whether the UE can perform inter-frequency SSB based measurements without the use of measurement gaps in the case that the SSB is completely contained in a CBW of the UE. In some embodiments, capability information may be indicated for different/independent frequency ranges where each indication corresponds to a frequency range of cells to be measured (e.g., a separate and/or individual set of capability information for each of FR1 and/or FR2 may be transmitted to the network).

In some embodiments, a network may send, to a UE, configuration information for performing an inter-frequency SSB measurement outside of an active BWP without using a measurement gap. For example, such configuration information may be provided in an interFrequencyOutsideBWPConfig-NoGap information element that is transmitted from the network to UE. In the case that the configuration information indicates that the inter-frequency SSB measurement outside of the active BWP and without a measurement gap is to be performed (e.g., if a corresponding field of the configuration information is set to true), the UE performs SSB based inter-frequency measurement without measurement gaps for an inter-frequency SSB that is located outside the active downlink (DL) BWP but within a UE CBW. Otherwise, measurement gaps are used to perform such SSB based inter-frequency measurements.

In new radio dual connectivity (NR-DC), the inter-frequency SSB measurement outside of the active BWP and without a measurement gap may be configured in a measConfig information element associated with a master cell group (MCG). It may be that when the measConfig information element is so configured, it applies with respect to all inter-frequency measurements configured/performed at each of the master node (MN) and the secondary node (SN) of the NR-DC arrangement.

In some embodiments, the network may provide the UE with a threshold that is associated with the use of the inter-frequency SSB measurement outside of the active BWP and without a measurement gap. For example, such a threshold may be sent in an interFrequencyOutsideBWPConfig-NoGap-threshold information element. In some cases, the threshold may correspond to an intra-frequency MO. In some cases, the threshold may correspond to one of a primary cell (PCell) and/or a primary secondary cell (PSCell) (and in some cases this may be the default assumption). If the result of a measurement on the MO corresponding to the threshold is above the threshold, then the UE may perform inter-frequency SSB measurement outside of the active BWP and without a measurement gap. Otherwise, the UE may perform such SSB measurements using measurement gaps.

One motivation for this use of a threshold is now explained. Note that while performing RRM measurement without using a measurement gap can increase the UE data throughput in various cases, it may not always be optimal to perform RRM measurement with a measurement gap in some cases when (also) accounting for mobility performance considerations. It may be that, for example, the UE associates a measurement result on the MO corresponding to the threshold that is lower than the threshold with a high-mobility circumstance for the UE (e.g., because a low (falling) measurement value for the MO is associated with a changing distance of the UE with respect to a base station).

Then, for example, take a case where a UE is to perform many intra-frequency measurements. In some wireless communication systems, it may be that the UE is assumed to have two independent searchers. Accordingly, it may be that the UE is capable of measuring two carriers outside of measurement gaps simultaneously. However, if the UE is configured with many intra-frequency measurement objects being measured without the use of a measurement gap (e.g., in a carrier aggregation (CA) cases where there are many secondary cells (SCells), as may be the case when a high-mobility circumstance applies at the UE), then measuring additional inter-frequency MO(s) without using measurement gaps would further increase congestion in the case of SSB measurement timing configuration (SMTC) alignment between the MOs. This congestion may ultimately result in latency with respect to acquiring measurements on the intra-frequency MOs. Depending on the particular deployment scenario, it may be better to perform inter-frequency measurements within measurement gaps, such that the mobility performance corresponding to the intra-frequency measurements can be prioritized.

Accordingly, with respect to the configuration/use of the threshold to determine whether to perform inter-frequency SSB measurement outside of the active BWP and without a measurement gap as described, the network may set the threshold to promote reliable procurement of intra-frequency measurements via the use/application of measurement gaps for inter-frequency measurements when the high-mobility circumstance applies. Otherwise (e.g., outside of the high-mobility circumstance), a relatively more efficient spectrum use is enabled by causing, through the operation of the threshold as described, the use of SSB based inter-frequency measurements without measurement gaps at the UE.

In some cases, information available to the UE may be relevant to considerations of whether to use inter-frequency SSB measurements outside of the active BWP and without measurement gaps. For example, a UE may be aware of its location relative to a base station based on its own communication with a global navigation satellite system (GNSS) and may correspondingly be configured to control or affect the consideration of whether to perform SSB based inter-frequency measurement outside of the active BWP with or without measurement gaps.

Accordingly, in some embodiments, the UE may provide the network with assistance information. For example, such assistance information may be provided to the network in an interFrequencyOutsideBWPAssistance-NoGap information element sent by the UE. It may be that such assistance information is provided on an MO basis.

In some cases, the assistance information indicates that the UE will perform an inter-frequency SSB measurement outside the active BWP on an inter-frequency MO corresponding to the assistance information. This corresponds to a UE-controlled case.

In some cases, the assistance information indicates that the UE can (optionally) perform and/or that the UE prefers to perform an inter-frequency SSB measurement outside the active BWP on an inter-frequency MO corresponding to the assistance information. After providing the assistance information, the UE waits for a network indication regarding whether to perform inter-frequency SSB measurement outside the active BWP on the inter-frequency MO. This corresponds to a network-controlled case. In some cases, the UE may also provide a latest measurement result for configured MOs (e.g., including but not limited to measurements on the PCell and/or the PSCell). Based on these measurement result(s), the network can determine whether an inter-frequency MO is to be measured with or without the use of a measurement gap and provide the UE with a corresponding indication.

In some wireless communications systems, the nature of an intra-frequency measurement without the use of a measurement gap may be defined. For example, in some NR wireless communications systems, an intra-frequency SSB based measurement without a measurement gap (e.g., without either of a full measurement gap or an NCSG) may be performed at a UE, provided that at least one of 1) that the UE indicates ‘no-gap’ via an intraFreq-needForGap for the intra-frequency measurement, 2) that the SSB to be measured is completely within the active BWP of the UE, and/or 3) that the active BWP is the initial BWP.

The second and third of these provisions correspond to scenarios where a target SSB is located within the active BWP of the UE. (Note that the diagram 200 of FIG. 2 illustrates an intra-frequency measurement consistent with these scenarios with respect to the first neighbor SSB 206).

It has been recognized that analogous extensions of enhancements of inter-frequency measurements without measurement gaps outside of an active BWP or initial BWP, as these have been discussed herein, may be applied to intra-frequency cases. Accordingly, embodiments for intra-frequency SSB measurement outside of an active BWP and without a measurement gap are discussed.

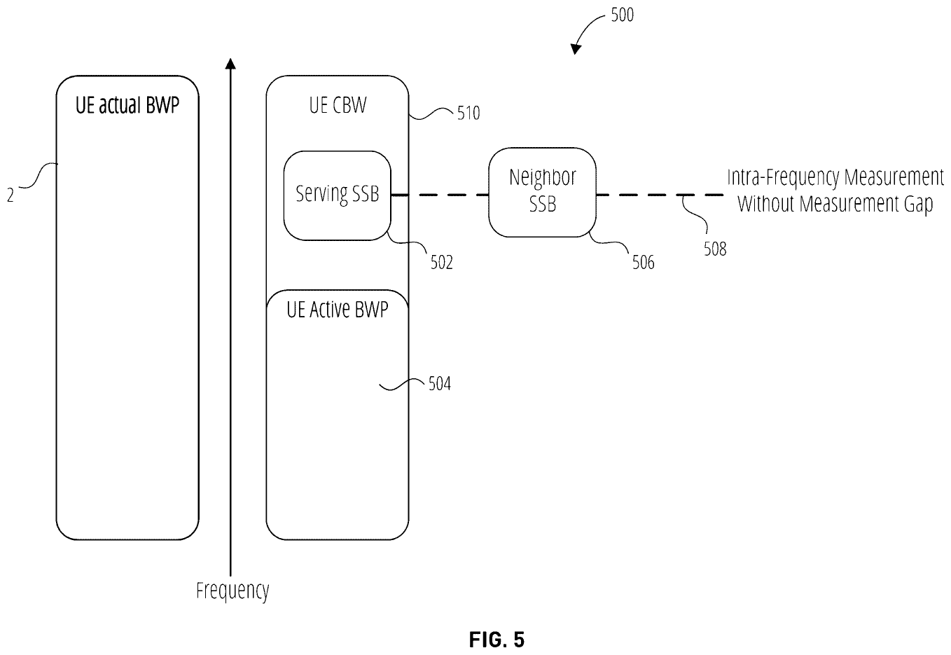

FIG. 5 illustrates a diagram 500 of a neighbor SSB 506 with respect to a serving SSB 502 that is outside a UE's active BWP 504, according to embodiments herein. The diagram 500 illustrates a carrier 508 corresponding to the active serving cell of the UE. As may be seen, the serving SSB 502 serves as an MO corresponding to that carrier 508 with respect to the serving cell and is outside the active BWP 504 of the UE (while being located within the UE CBW 510).

Further, as illustrated, the neighbor SSB 506 also serves as an MO corresponding to the carrier 508. The neighbor SSB 506 is (also) located outside of the active BWP 504 (while being located within the UE CBW 510).

In some cases, an intra-frequency measurement of the second neighbor SSB 506 may be performed by the UE without the use of a measurement gap. For example, it may be that the UE is capable of using an actual BWP 512 that is larger than the active BWP 504, and that the neighbor SSB 506 is located within this actual BWP 512. Under such circumstances, the UE may receive and perform measurement on the neighbor SSB 506 while simultaneously performing Rx/Tx functions corresponding to the defined active BWP 504 by functionally applying the actual BWP 512.

In some embodiments, a UE may send capability information to the network that indicates whether the UE is capable of performing intra-frequency measurements without using a measurement gap. For example, such capability information may be provided in an intraFrequencyMeasOutsideBWP-NoGap information element that is transmitted to the network by the UE. Capability information may indicate, for example, whether the UE can perform intra-frequency SSB based measurements without the use of measurement gaps in the case that the SSB is completely contained in a CBW of the UE. In some embodiments, capability information may be indicated for different/independent frequency ranges where each indication corresponds to a frequency range of cells to be measured (e.g., a separate and/or individual set of capability information for each of FR1 and/or FR2 may be transmitted to the network).

In some embodiments, a network may send configuration information for performing an intra-frequency SSB measurement outside of an active BWP without using a measurement gap. For example, such configuration information may be provided in an intraFrequencyOutsideBWPConfig-NoGap information element that is transmitted from the network to UE. In the case that the configuration information indicates that the intra-frequency SSB measurement outside of the active BWP and without a measurement gap is to be performed (e.g., if a corresponding field of the configuration information is set to true), the UE performs SSB based intra-frequency measurement without measurement gaps for an intra-frequency SSB that is located outside the active DL BWP but within UE CBW. Otherwise, measurement gaps are used to perform such SSB based intra-frequency measurements.

In NR-DC, the intra-frequency SSB measurement outside of the active BWP and without a measurement gap may be configured in a measConfig information element associated with an MCG. It may be that when the measConfig information element is so configured, it applies with respect to all intra-frequency measurements configured/performed at each of the MN and the SN of the NR-DC arrangement.

In some embodiments, the network may provide the UE with a threshold that is associated with the use of the intra-frequency SSB measurement outside of the active BWP and without a measurement gap. For example, such a threshold may be sent in an intraFrequencyOutsideBWPConfig-NoGap-threshold information element. In some cases, the threshold may correspond to an intra-frequency MO. In some cases, the threshold may correspond to one of a PCell and/or a PSCell (and in some cases this may be the default assumption). If the result of a measurement on the MO corresponding to the threshold is above the threshold, then the UE may perform intra-frequency SSB measurement outside of the active BWP and without a measurement gap. Otherwise, the UE may perform such SSB measurements using measurement gaps.

As is discussed herein, the comparison of a measurement of an MO corresponding to a threshold with the threshold may correspond to the mobility state of the UE. Accordingly, with respect to the configuration/use of the threshold to determine whether to perform intra-frequency SSB measurement outside of the active BWP and without a measurement gap as described, the network may set the threshold promote reliable procurement of the intra-frequency measurements via the use/application of measurement gaps for the intra-frequency measurements when the high-mobility circumstance applies. For example, it may be that under a high-mobility circumstance, without the use of measurement gaps, there may be a relatively higher chance of congestion due to SMTC alignment as between the intra-frequency carriers. Otherwise (e.g., outside of the high-mobility circumstance), a relatively more efficient spectrum use is enabled by causing, through the operation of the threshold as described, the use of SSB based intra-frequency measurement without measurement gaps at the UE.

In some cases, information available to the UE may be relevant to considerations of whether to use intra-frequency SSB measurements outside of the active BWP and without measurement gaps. For example, a UE may be aware of its location relative to a base station based on its own communication with a GNSS and may correspondingly be configured to control or affect the consideration of whether to perform SSB based intra-frequency measurement outside of the active BWP with or without measurement gaps.

Accordingly, in some embodiments, the UE may provide the network with assistance information. For example, such assistance information may be provided to the network in an intraFrequencyOutsideBWPAssistance-NoGap information element sent by the UE. It may be that such assistance information is provided on an MO basis.

In some cases, the assistance information indicates that the UE will perform an intra-frequency SSB measurement outside the active BWP on an intra-frequency MO corresponding to the assistance information. This corresponds to a UE-controlled case.

In some cases, the assistance information indicates that the UE can (optionally) perform and/or that the UE prefers to perform an intra-frequency SSB measurement outside the active BWP on an intra-frequency MO corresponding to the assistance information. After providing the assistance information, the UE waits for a network indication regarding whether to perform intra-frequency SSB measurement outside the active BWP on the intra-frequency MO. This corresponds to a network-controlled case. In some cases, the UE may also provide a latest measurement result for configured MOs (e.g., including but not limited to measurements on the PCell and/or the PSCell). Based on these measurement result(s), the network can determine whether an intra-frequency MO is to be measured with or without the use of a measurement gap and provide the UE with a corresponding indication.

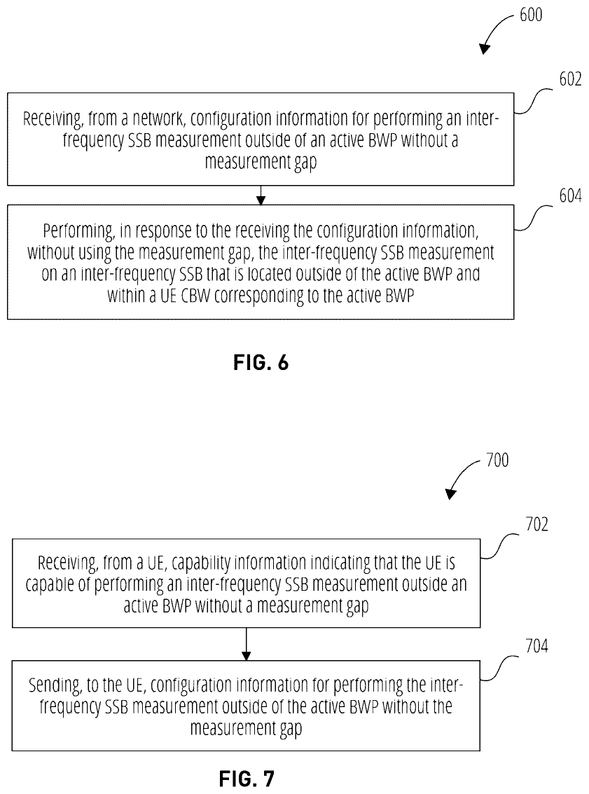

FIG. 6 illustrates a method 600 of a UE, according to embodiments herein. The method 600 includes receiving 602, from a network, configuration information for performing an inter-frequency SSB measurement outside of an active BWP without a measurement gap. The method 600 further includes performing 604, in response to the receiving the configuration information, without using the measurement gap, the inter-frequency SSB measurement on an inter-frequency SSB that is located outside of the active BWP and within a UE CBW corresponding to the active BWP.

In some embodiments, the method 600 further includes sending, to the network, capability information indicating that the UE is capable of performing the inter-frequency SSB measurement outside the active BWP without the measurement gap. In some such embodiments, the capability information indicates that the UE is capable of performing the inter-frequency SSB measurement within an indicated frequency range.

In some embodiments, the method 600 further includes receiving, from the network, a threshold for an inter-frequency MO; and determining that a measurement of the inter-frequency MO is higher than the threshold for the inter-frequency MO; wherein the inter-frequency SSB measurement on the inter-frequency SSB is performed in response to the determining that the measurement of the inter-frequency MO is higher than the threshold for the inter-frequency MO.

In some embodiments, the method 600 further includes receiving, from the network, a threshold for one of a primary cell (PCell) and a primary secondary cell (PSCell); and determining that a measurement of the one of the PCell and the PSCell is higher than the threshold for the one of the PCell and the PSCell; wherein the inter-frequency SSB measurement on the inter-frequency SSB is performed in response to the determining that the measurement of the one of the PCell and the PSCell is higher than the threshold for the one of the PCell and the PSCell.

In some embodiments, the method 600 further includes sending, to the network, assistance information indicating that the UE will perform the inter-frequency SSB measurement on an inter-frequency MO.

In some embodiments, the method 600 further includes sending, to the network, assistance information indicating that the UE can perform the inter-frequency SSB measurement on an inter-frequency MO; and receiving, from the network, an indication to perform the inter-frequency SSB measurement. In some such embodiments, the assistance information further comprises a measurement result for one of a PCell and a PSCell.

FIG. 7 illustrates a method 700 of a RAN, according to embodiments herein. The method 700 includes receiving 702, from a UE, capability information indicating that the UE is capable of performing an inter-frequency SSB measurement outside an active BWP without a measurement gap. The method 700 further includes sending 704, to the UE, configuration information for performing the inter-frequency SSB measurement outside of the active BWP without the measurement gap.

In some embodiments of the method 700, the capability information indicates that the UE is capable of performing the inter-frequency SSB measurement within an indicated frequency range.

In some embodiments, the method 700 further includes sending, to the UE, a threshold for an inter-frequency MO.

In some embodiments, the method 700 further includes sending, to the UE, a threshold for one of a PCell and a PSCell.

In some embodiments, the method 700 further includes receiving, from the UE, assistance information indicating that the UE will perform the inter-frequency SSB measurement on an inter-frequency MO.

In some embodiments, the method 700 further includes receiving, from the UE, assistance information indicating that the UE can perform the inter-frequency SSB measurement on an inter-frequency MO; and sending, to the UE, an indication to perform the inter-frequency SSB measurement. In some such embodiments, the assistance information further comprises a measurement result for one of a PCell and a PSCell.

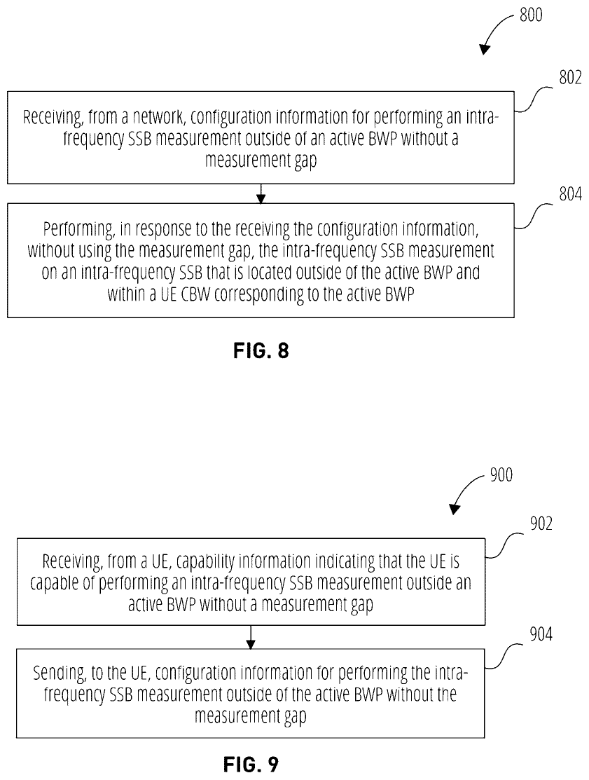

FIG. 8 illustrates a method 800 of a UE, according to embodiments herein. The method 800 includes receiving 802, from a network, configuration information for performing an intra-frequency SSB measurement outside of an active BWP without a measurement gap. The method 800 further includes performing 804, in response to the receiving the configuration information, without using the measurement gap, the intra-frequency SSB measurement on an intra-frequency SSB that is located outside of the active BWP and within a UE CBW corresponding to the active BWP.

In some embodiments, the method 800 further includes sending, to the network, capability information indicating that the UE is capable of performing the intra-frequency SSB measurement outside the active BWP without the measurement gap. In some such embodiments, the capability information indicates that the UE is capable of performing the intra-frequency SSB measurement within an indicated frequency range.

In some embodiments, the method 800 further includes receiving, from the network, a threshold for an intra-frequency MO; and determining that a measurement of the intra-frequency MO is higher than the threshold for the intra-frequency MO; wherein the intra-frequency SSB measurement on the intra-frequency SSB is performed in response to the determining that the measurement of the intra-frequency MO is higher than the threshold for the intra-frequency MO.

In some embodiments, the method 800 further includes receiving, from the network, a threshold for one of a PCell and a PSCell; and determining that a measurement of the one of the PCell and the PSCell is higher than the threshold for the one of the PCell and the PSCell; wherein the intra-frequency SSB measurement on the intra-frequency SSB is performed in response to the determining that the measurement of the one of the PCell and the PSCell is higher than the threshold for the one of the PCell and the PSCell.

In some embodiments, the method 800 further includes sending, to the network, assistance information indicating that the UE will perform the intra-frequency SSB measurement on an intra-frequency MO.

In some embodiments, the method 800 further includes sending, to the network, assistance information indicating that the UE can perform the intra-frequency SSB measurement on an intra-frequency MO; and receiving, from the network, an indication to perform the intra-frequency SSB measurement. In some such embodiments, the assistance information further comprises a measurement result for one of a PCell and a PSCell.

FIG. 9 illustrates a method 900 of a RAN, according to embodiments herein. The method 900 includes receiving 902, from a UE, capability information indicating that the UE is capable of performing an intra-frequency SSB measurement outside an active BWP without a measurement gap. The method 900 further includes sending 904, to the UE, configuration information for performing the intra-frequency SSB measurement outside of the active BWP without the measurement gap.

In some embodiments of the method 900, the capability information indicates that the UE is capable of performing the intra-frequency SSB measurement within an indicated frequency range.

In some embodiments, the method 900 further includes sending, to the UE, a threshold for an intra-frequency MO.

In some embodiments, the method 900 further includes sending, to the UE, a threshold for one of a PCell and a PSCell.

In some embodiments, the method 900 further includes receiving, from the UE, assistance information indicating that the UE will perform the intra-frequency SSB measurement on an intra-frequency MO.

In some embodiments, the method 900 further includes receiving, from the UE, assistance information indicating that the UE can perform the intra-frequency SSB measurement on an intra-frequency MO; and sending, to the UE, an indication to perform the intra-frequency SSB measurement. In some such embodiments, the assistance information further comprises a measurement result for one of a PCell and a PSCell.

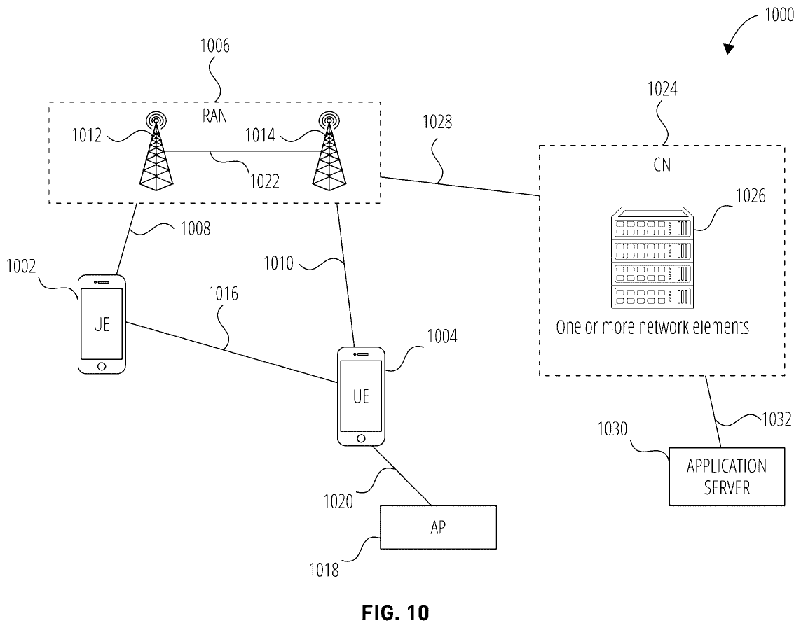

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

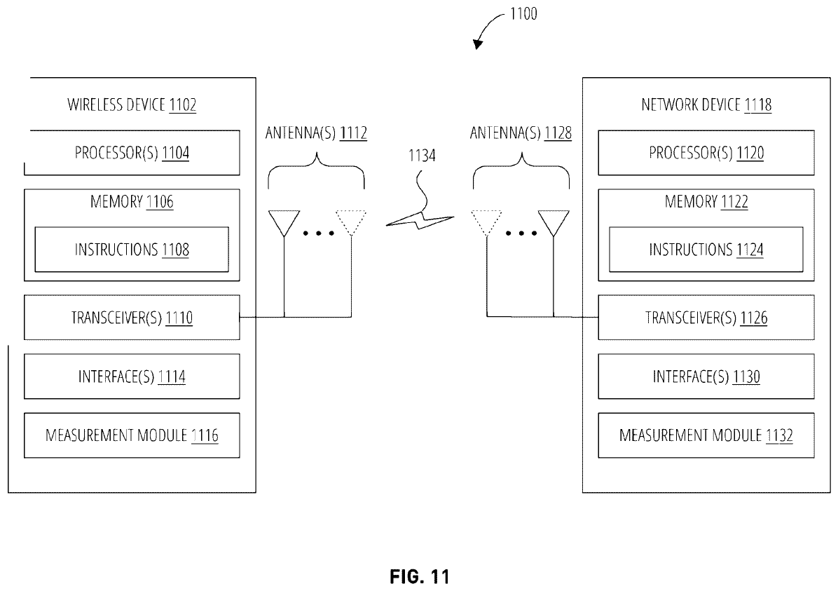

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include RF transmitter and/or receiver circuitry that uses the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a measurement module 1116. The measurement module 1116 may be implemented via hardware, software, or combinations thereof. For example, the measurement module 1116 may be implemented as a processor, circuit, and/or instructions 1108 stored in the memory 1106 and executed by the processor(s) 1104. In some examples, the measurement module 1116 may be integrated within the processor(s) 1104 and/or the transceiver(s) 1110. For example, the measurement module 1116 may be implemented by a combination of software components (e.g., executed by a DSP or a general processor) and hardware components (e.g., logic gates and circuitry) within the processor(s) 1104 or the transceiver(s) 1110.

The measurement module 1116 may be used for various aspects of the present disclosure, for example, aspects of FIG. 1 to FIG. 5. For example, the measurement module 1116 may be configured to perform one or more inter-frequency and/or intra-frequency measurements outside of an active BWP and without a measurement gap, to generate capability information, to compare a measurement of an MO to a corresponding threshold, and/or to generate assistance information as is discussed herein.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter and/or receiver circuitry that uses the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include a measurement module 1132. The measurement module 1132 may be implemented via hardware, software, or combinations thereof. For example, the measurement module 1132 may be implemented as a processor, circuit, and/or instructions 1124 stored in the memory 1122 and executed by the processor(s) 1120. In some examples, the measurement module 1132 may be integrated within the processor(s) 1120 and/or the transceiver(s) 1126. For example, the measurement module 1132 may be implemented by a combination of software components (e.g., executed by a DSP or a general processor) and hardware components (e.g., logic gates and circuitry) within the processor(s) 1120 or the transceiver(s) 1126.

The measurement module 1132 may be used for various aspects of the present disclosure, for example, aspects of FIG. 1 through FIG. 5. The measurement module 1132 may generate configuration information corresponding to the use of inter-frequency and/or intra-frequency measurements outside of an active BWP and without a measurement gap, to utilize received capability information, to generate threshold corresponding to a MO, and/or to utilize received assistance information as is discussed herein.

Embodiments contemplated herein include an apparatus comprising means to perform one or more elements of any of the method 600 and the method 800. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 600 and the method 800. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of any of the method 600 and the method 800. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 600 and the method 800. This apparatus may be, for example, an apparatus of a UE (such as a wireless device 1102 that is a UE, as described herein).

Embodiments contemplated herein include a signal as described in or related to one or more elements of any of the method 600 and the method 800.

Embodiments contemplated herein include a computer program or computer program product comprising instructions, wherein execution of the program by a processor is to cause the processor to carry out one or more elements of any of the method 600 and the method 800. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

Embodiments contemplated herein include an apparatus comprising means to perform one or more elements of any of the method 700 and the method 900. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 700 and the method 900. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of any of the method 700 and the method 900. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 700 and the method 900. This apparatus may be, for example, an apparatus of a base station (such as a network device 1118 that is a base station, as described herein).

Embodiments contemplated herein include a signal as described in or related to one or more elements of any of the method 700 and the method 900.

Embodiments contemplated herein include a computer program or computer program product comprising instructions, wherein execution of the program by a processing element is to cause the processing element to carry out one or more elements of any of the method 700 and the method 900. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, configuration information for performing an inter-frequency synchronization signal block (SSB) measurement outside of an active bandwidth part (BWP) without a measurement gap; and
performing, in response to the receiving the configuration information, without using the measurement gap, the inter-frequency SSB measurement on an inter-frequency SSB that is located outside of the active BWP and within a UE channel bandwidth (CBW) corresponding to the active BWP.

2. The method of claim 1, further comprising sending, to the network, capability information indicating that the UE is capable of performing the inter-frequency SSB measurement outside the active BWP without the measurement gap.

3. The method of claim 2, wherein the capability information indicates that the UE is capable of performing the inter-frequency SSB measurement within an indicated frequency range.

4. The method of claim 1, further comprising:
receiving, from the network, a threshold for an inter-frequency measurement object (MO); and
determining that a measurement of the inter-frequency MO is higher than the threshold for the inter-frequency MO;
wherein the inter-frequency SSB measurement on the inter-frequency SSB is performed in response to the determining that the measurement of the inter-frequency MO is higher than the threshold for the inter-frequency MO.

5. The method of claim 1, further comprising:
receiving, from the network, a threshold for one of a primary cell (PCell) and a primary secondary cell (PSCell); and
determining that a measurement of the one of the PCell and the PSCell is higher than the threshold for the one of the PCell and the PSCell;
wherein the inter-frequency SSB measurement on the inter-frequency SSB is performed in response to the determining that the measurement of the one of the PCell and the PSCell is higher than the threshold for the one of the PCell and the PSCell.

6. The method of claim 1, further comprising sending, to the network, assistance information indicating that the UE will perform the inter-frequency SSB measurement on an inter-frequency measurement object (MO).

7. The method of claim 1, further comprising:
sending, to the network, assistance information indicating that the UE can perform the inter-frequency SSB measurement on an inter-frequency measurement object (MO); and
receiving, from the network, an indication to perform the inter-frequency SSB measurement.

8. The method of claim 7, wherein the assistance information further comprises a measurement result for one of a primary cell (PCell) and a primary secondary cell (PSCell).

9. A method of a radio access network (RAN), comprising:
receiving, from a user equipment (UE), capability information indicating that the UE is capable of performing an inter-frequency synchronization signal block (SSB) measurement outside an active bandwidth part (BWP) without a measurement gap; and
sending, to the UE, configuration information for performing the inter-frequency SSB measurement outside of the active BWP without the measurement gap.

10. The method of claim 9, wherein the capability information indicates that the UE is capable of performing the inter-frequency SSB measurement within an indicated frequency range.

11. The method of claim 9, further comprising sending, to the UE, a threshold for an inter-frequency measurement object (MO).

12. The method of claim 9, further comprising sending, to the UE, a threshold for one of a primary cell (PCell) and a primary secondary cell (PSCell).

13. The method of claim 9, further comprising receiving, from the UE, assistance information indicating that the UE will perform the inter-frequency SSB measurement on an inter-frequency measurement object (MO).

14. The method of claim 9, further comprising:
receiving, from the UE, assistance information indicating that the UE can perform the inter-frequency SSB measurement on an inter-frequency measurement object (MO); and
sending, to the UE, an indication to perform the inter-frequency SSB measurement.

15. The method of claim 14, wherein the assistance information further comprises a measurement result for one of a primary cell (PCell) and a primary secondary cell (PSCell).

16. A method of a user equipment (UE), comprising:
receiving, from a network, configuration information for performing an intra-frequency synchronization signal block (SSB) measurement outside of an active bandwidth part (BWP) without a measurement gap; and
performing, in response to the receiving the configuration information, without using the measurement gap, the intra-frequency SSB measurement on an intra-frequency SSB that is located outside of the active BWP and within a UE channel bandwidth (CBW) corresponding to the active BWP.

17. The method of claim 16, further comprising sending, to the network, capability information indicating that the UE is capable of performing the intra-frequency SSB measurement outside the active BWP without the measurement gap.

18. The method of claim 17, wherein the capability information indicates that the UE is capable of performing the inter-frequency SSB measurement within an indicated frequency range.

19. The method of claim 16, further comprising:
receiving, from the network, a threshold for an intra-frequency measurement object (MO); and
determining that a measurement of the intra-frequency MO is higher than the threshold for the intra-frequency MO;
wherein the intra-frequency SSB measurement on the intra-frequency SSB is performed in response to the determining that the measurement of the intra-frequency MO is higher than the threshold for the intra-frequency MO.

20. The method of claim 16, further comprising:
receiving, from the network, a threshold for one of a primary cell (PCell) and a primary secondary cell (PSCell); and
determining that a measurement of the one of the PCell and the PSCell is higher than the threshold for the one of the PCell and the PSCell;
wherein the intra-frequency SSB measurement on the intra-frequency SSB is performed in response to the determining that the measurement of the one of the PCell and the PSCell is higher than the threshold for the one of the PCell and the PSCell.

21-30. (canceled)
